(19) United States
(12) Patent Application Publication
(10) Pub. No.: US 2013/0055332 A1
(43) Pub. Date: Feb. 28, 2013

(54) BROADCAST RECEIVER APPARATUS AND BROADCAST RECEPTION METHOD

(71) Applicant: Tatsuya Nishi, Kanagawa (JP)

(72) Inventor: Tatsuya Nishi, Kanagawa (JP)

(73) Assignee: PANASONIC CORPORATION, Osaka (JP)

(21) Appl. No.: 13/643,756

(22) PCT Filed: Feb. 23, 2011
(86) PCT No.: PCT/JP2011/001029

§ 371 Date: Oct. 26, 2012

(30) Foreign Application Priority Data
Apr. 27, 2010 (JP) 2010-102294

(51) Int. Cl. H04N 21/45

(52) U.S. Cl. 725/131

(57) ABSTRACT

This invention provides a broadcast receiver apparatus capable of reducing power consumption that is not intended by the user. The broadcast receiver apparatus (100) comprises: a reception processing unit (140) for receiving the broadcast data of a program by switching between a high definition broadcast system and a low definition broadcast system that consumes less power than the high definition broadcast system; audio and video processing units (150, 170) for outputting the program based on the received broadcast data; and a broadcast standard switch processing unit (250) for causing the reception processing unit (140) to switch to the low definition broadcast system on the condition that no terminal operation has been done in response to a program change in the high definition broadcast system.

### TECHNICAL FIELD

The present invention relates to a portable broadcast receiving apparatus and a broadcast receiving method for the apparatus.

### BACKGROUND ART

Portable apparatuses have become popular in recent years with which the user can view broadcast programs, such as mobile phones and mobile televisions corresponding to one-segment broadcast, a broadcast service using one segment among a plurality of segments. Such apparatuses operate on battery power and thus it is important to reduce power consumption.

In this respect, a technique is disclosed in which an operation of a decoding process is switched to an operation consuming less power when the remaining battery level is a threshold or less (see PLT 1). This technique can extend a time in which the battery power can last without impairing the user's comfortability with viewing programs where possible.

### CITATION LIST

### Patent Literature

### PTL 1

Japanese Patent Application Laid-Open No. 2008-124646

### SUMMARY OF INVENTION

### Technical Problem

By the way, a reception process using a high-quality broadcasting scheme consumes large power. Examples of the high-quality broadcasting scheme include full-segment broadcast which is a broadcast service using all segments of a plurality of segments. Hence, even when the technique disclosed in PLT 1 is employed, a larger amount of battery power than expected by the user may be consumed.

It is an object of the present invention to provide a broadcast receiving apparatus and a broadcast receiving method that can reduce waste power consumption which may not be expected by the user.

### Solution to Problem

A broadcast receiving apparatus according to the present invention includes: a reception processing section that receives broadcast data of a program by switching broadcasting schemes between a high-quality broadcasting scheme and a low-quality broadcasting scheme consuming less power than the high-quality broadcasting scheme; a program output section that outputs the program based on the received broadcast data; and a broadcast standard switching processing section that, in the high-quality broadcasting scheme, causes the reception processing section to switch the broadcasting schemes to the low-quality broadcasting scheme if no terminal operation is performed in response to a change of the program to the next one.

A broadcast receiving method according to the present invention includes: starting reception of broadcast data of a program in accordance with a high-quality broadcasting scheme; starting output of the program based on the received broadcast data; determining whether a terminal operation is performed in response to a change of the program to the next one; and switching schemes for the reception from the high-quality broadcasting scheme to a low-quality broadcasting scheme if the terminal operation is not performed in response to the change in program, the low-quality broadcasting scheme consuming less power than the high-quality broadcasting scheme.

### Advantageous Effects of Invention

According to the present invention, the broadcasting scheme can be switched to a low-quality scheme consuming less power when the terminal is not being operated even though the program has changed to the next one, i.e. there is a high probability that the user is not viewing the program. With this configuration, the present invention can reduce waste power consumption which may not be expected by the user.

### BRIEF DESCRIPTION OF DRAWINGS

FIG. 1 is a block diagram of a configuration of a broadcast receiving terminal as a broadcast receiving apparatus according to an embodiment of the present invention;

FIG. 2 is a block diagram of a configuration of an operation status detection section according to the present embodiment;

FIG. 3 is a flowchart showing an operation of the operation status detection section according to the present embodiment; and

FIG. 4 is a flowchart showing an operation of a broadcast standard switching processing section according to the present embodiment.

### DESCRIPTION OF EMBODIMENTS

An embodiment of the present invention will now be described in detail with reference to the accompanying drawings.

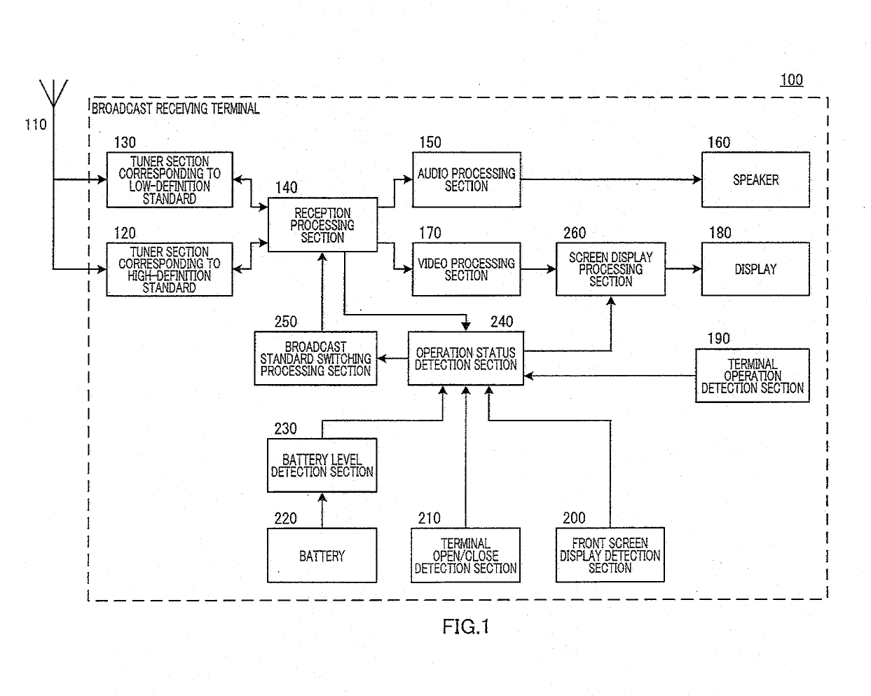

FIG. 1 is a block diagram of a configuration of a broadcast receiving terminal as a broadcast receiving apparatus according to an embodiment of the present invention. The present embodiment describes an example in which the present invention is applied to a folding mobile phone for receiving the digital terrestrial television broadcast by switching from full-segment broadcast to one-segment broadcast and vice versa.

Broadcast antenna 110 receives broadcast signals of the digital terrestrial television broadcast that broadcasts television programs, and outputs the received broadcast signals to tuner section 120 corresponding to high-definition standard and tuner section 130 corresponding to low-definition standard.

In response to control by reception processing section 140, tuner section 120 corresponding to a high-definition standard performs a demodulation process such as 64QAM on signals of a channel of full-segment broadcast among the received broadcast signals. Full-segment broadcast is a standard for high-definition (high-quality) broadcast. Tuner section 120 corresponding to a high-definition standard outputs the demodulated stream data of full-segment broadcast to reception processing section 140.

In response to control by reception processing section 140, tuner section 130 corresponding to a low-definition standard performs a demodulation process such as QPSK on signals of a channel of one-segment broadcast among the received broadcast signals. One-segment broadcast is a low-quality standard for mobile devices consuming less power. Tuner section 130 corresponding to a low-definition standard outputs the demodulated stream data of one-segment broadcast to reception processing section 140.

Reception processing section 140 operates by switching stream data between full-segment broadcast and one-segment broadcast (hereinafter collectively referred to as “broadcast data”) when receiving the stream data. Reception processing section 140 performs a reception process including a decoding process, such as moving picture experts group-2 (MPEG-2), on the stream data of full-segment broadcast. Reception processing section 140 performs a reception process including a decoding process, such as H.264, on the stream data of one-segment broadcast. During the reception process, reception processing section 140 acquires audio data, video data, and program information from the broadcast data. The program information includes at least information for determining the program of broadcast data that is being received and information about the end time of the program.

Reception processing section 140 outputs the audio data to audio processing section 150 and outputs the video data to video processing section 170. Reception processing section 140 outputs the program information and broadcast standard information to operation status detection section 240. The broadcast standard information is information indicating either the status for receiving full-segment broadcast (hereinafter referred to as “high-definition standard”) or the status for receiving one-segment broadcast (hereinafter referred to as “low-definition standard”).

Audio processing section 150 converts the received audio data into analog audio signals that can be output from speaker 160, and outputs the signals to speaker 160.

Speaker 160 is a loud speaker, for example, and converts the received analog audio signals into audio and outputs the audio. That is, speaker 160 outputs audio of programs.

Video processing section 170 converts the received video data into video signals that can be processed in display 180 and outputs the video signals to display 180 via screen display processing section 260.

Display 180 is a liquid crystal display, for example, and displays images based on the received video signals. That is, display 180 outputs video images of programs.

Terminal operation detection section 190 is a touch panel arranged on the above liquid crystal display or a key switch, for example, and detects a user operation of broadcast receiving terminal 100 (hereinafter referred to as “terminal operation”). Terminal operation detection section 190 outputs operation information indicating contents of the detected terminal operation to operation status detection section 240.

When the terminal displays an application other than a television application, front screen display detection section 200 detects the status. Front screen display detection section 200 outputs display status information indicating whether the application other than the television application is displayed to operation status detection section 240. When using a mobile phone, generally, the user can operate other applications such as email software, even during the operation of the television application. Thus, it is possible to determine whether the terminal operation currently undergoing is the operation of the television application from the display status information. Hereinafter, the terminal operation for the television application is referred to as “television operation.”

Terminal open/close detection section 210 is a rotary switch, for example, and detects whether broadcast receiving terminal 100 is in an opened or closed status. Terminal open/close detection section 210 outputs open/close status information indicating whether the terminal is in the opened or closed status to operation status detection section 240. It is possible to determine whether video images of the television application are displayed on the screen from the open/close status information.

Battery 220 is a lithium ion battery, for example, and stores power for the operation of broadcast receiving terminal 100.

Battery level detection section 230 detects the remaining power level of battery 220 (hereinafter referred to as “battery level”) and outputs battery level information indicating the battery level to operation status detection section 240.

Operation status detection section 240 determines whether the television operation has been performed in response to a change in program to the next one (hereinafter referred to as “program change”) in the high-definition standard. Hereinafter, a time in which no television operation is performed and the length of the time are correctively referred to as “non-operation time.”

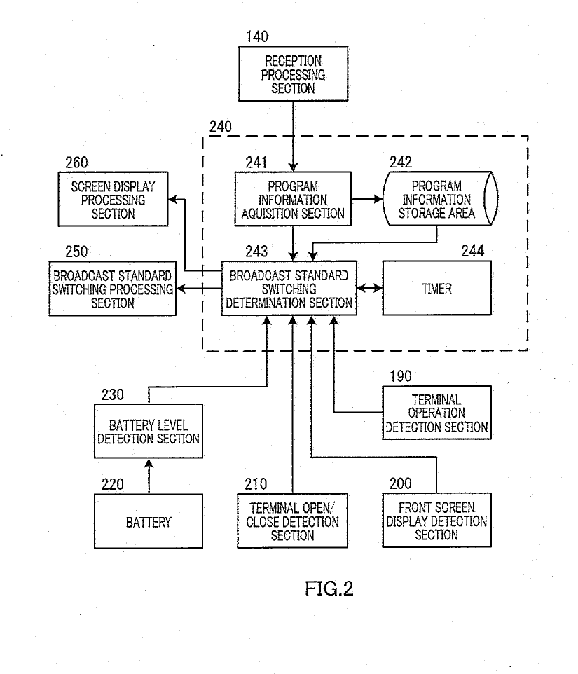

FIG. 2 is a block diagram of a configuration of operation status detection section 240 according to the present embodiment. For easier explanation, the peripheral functional sections of operation status detection section 240 are also shown in FIG. 2.

Program information acquisition section 241 acquires the program information and broadcast standard information from reception processing section 140. Program information acquisition section 241 outputs the broadcast standard information to broadcast standard switching determination section 243 and outputs the program information to broadcast standard switching determination section 243 and program information storage area 242.

Broadcast standard switching determination section 243 determines whether the broadcast information is the high-definition standard based on the received broadcast standard information. Furthermore, broadcast standard switching determination section 243 compares the past program information stored in program information storage area 242 with the received current program information, and determines whether program change has been performed. Furthermore, broadcast standard switching determination section 243 determines whether the television operation is performed in response to program change in the high-definition standard, using timer 244. Specifically, broadcast standard switching determination section 243 determines whether all of the following three operations are performed based on the received operation information, display status information, and terminal open/close information: whether the terminal operation is performed, the television application is displayed, and the terminal is in the opened status. Then, broadcast standard switching determination section 243 determines that the television operation has been performed when the terminal operation is performed, when the television application is displayed, and when the terminal is in the opened status.

Broadcast standard switching determination section 243 outputs a broadcast standard instruction, to broadcast standard switching processing section 250, giving an instruction to switching to the low-definition standard when program change occurs during non-operation time or a predetermined time after the non-operation time. Broadcast standard switching determination section 243 outputs a broadcast standard instruction giving an instruction on switching to the high-definition standard to broadcast standard switching processing section 250 when the television operation is performed in the low-definition standard.

Furthermore, broadcast standard switching determination section 243 outputs a broadcast standard instruction giving an instruction on the end of the broadcast reception (end of the television application) to broadcast standard switching processing section 250 when the battery level is a predetermined threshold value or less or the non-operation time is a predetermined threshold value or greater in the low-definition standard.

Furthermore, broadcast standard switching determination section 243 outputs switching operation information indicating information about switching of broadcasting schemes (hereinafter referred to as “broadcasting scheme switching”) to screen display processing section 260. The switching operation information indicates non-operation time up to the current time, the program change, broadcasting scheme switching, and the existence or absence of the television operation, for example.

Screen display processing section 260 of FIG. 1 generates an image indicating contents of the received switching operation information and superimposes the image on the video signals received in display 180 to display the image on display 180. The image displayed by screen display processing section 260 is a predetermined pictogram (icon), for example. The predetermined pictogram changes its form such as the color or design according to, for example, an elapsed time after the last television operation. Alternatively, the predetermined pictogram changes its form at the timing when the program change, broadcasting scheme switching, or the television operation (i.e. initialization of the elapsed time after the last television operation) occurs. This enables the user to know the status of operation about power reduction of broadcast receiving terminal 100 and to maintain the high-definition standard by appropriately performing a television operation (described later).

Broadcast standard switching processing section 250 causes reception processing section 140 to switch the broadcasting schemes for the reception process or to stop the reception process, based on the received broadcast standard instruction.

Broadcast receiving terminal 100 may be configured by, for example, a central processing unit (CPU), a storage medium such as a read only memory (ROM) storing a control program, a working memory such as a random access memory (RAM), and a radio communication circuit, all of which are not shown. That is, functions of above sections can be achieved by a control program performed by the CPU. Furthermore, in broadcast receiving terminal 100, application software with which the user can view digital terrestrial television broadcast (hereinafter referred to as “television application”) is achieved through functions of components ranging from broadcast antenna 110 to display 180.

Generally, an user viewing the digital television broadcast performs operations such as channel switching or volume adjustment before and after program change. Thus, the user is not likely to be viewing the program, for example, in the case where the user does not perform any television operation within the time from ten minutes before to one minute after program change even though the program change occurs.

By the way, less power is consumed in the demodulation and decoding processes of stream data of one-segment broadcast compared to those of stream data of full-segment broadcast. Continuation of the broadcast in the high-definition standard consuming large power while the user is not viewing the program leads to waste power consumption which may not be expected by the user.

To overcome the above problem, broadcast receiving terminal 100 having the above configuration switches the broadcasting schemes to the low-definition standard if no television operation is performed in response to the program change in the high-definition standard. With this configuration, in the case where program change occurs while the user is not viewing the program, broadcast receiving terminal 100 can switch the broadcasting schemes to the low-definition broadcast that consumes less power. Thus, it is possible to reduce waste power consumption which may not be expected by the user.

The operation of broadcast receiving terminal 100 will now be explained.

While broadcast receiving terminal 100 is being operated, operation status detection section 240 continuously receives program information, operation information, terminal open/close information, display status information, and battery level information. In response to control on broadcasting scheme switching from broadcast standard switching processing section 250, reception processing section 140 continuously outputs the audio data, video data, and program information.

That is, the operation of broadcast receiving terminal 100 is achieved mainly by operations of operation status detection section 240 and broadcast standard switching processing section 250. Hence, in the present embodiment, mainly, the operations of operation status detection section 240 and broadcast standard switching processing section 250 will now be explained.

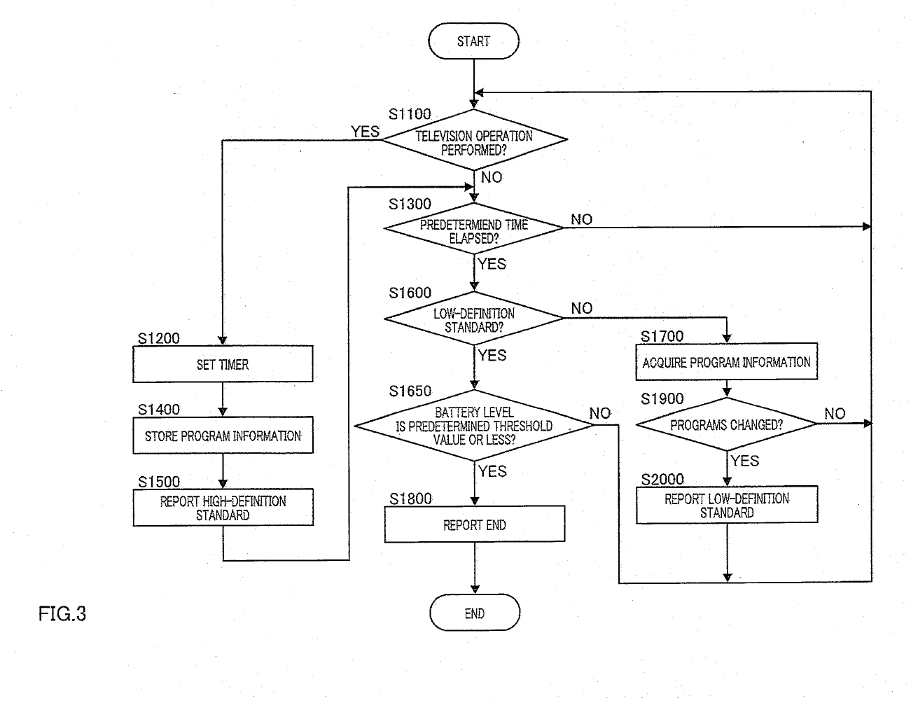

FIG. 3 is a flowchart showing the operation of operation status detection section 240. Program information acquisition section 241 of operation status detection section 240 continuously outputs the broadcast standard information to broadcast standard switching determination section 243.

First, in step S1100, operation status detection section 240 allows broadcast standard switching determination section 243 to determine whether broadcast receiving terminal 100 receives a new television operation based on the operation information and display status information. If the television operation is performed (S1100: YES), operation status detection section 240 proceeds to step S1200. If no television operation is performed (S1100: NO), operation status detection section 240 proceeds to step S1300 (described later).

In step S1200, operation status detection section 240 sets timer 244 at the initial value of 0 and starts to count time in timer 244 in broadcast standard switching determination section 243.

Then, in step S1400, operation status detection section 240 acquires the program information in program information acquisition section 241 and stores the program information in program information storage area 242.

Then, in step S1500, operation status detection section 240 allows broadcast standard switching determination section 243 to output a broadcast standard instruction giving an instruction on switching to the high-definition standard to broadcast standard switching processing section 250.

In step S1300, operation status detection section 240 determines whether the counted value of timer 244 reaches a predetermined time in broadcast standard switching determination section 243. That is, operation status detection section 240 determines whether non-operation time reaches the predetermined time after the last television operation. Operation status detection section 240 returns to step S1100 if the non-operation time does not reach the predetermined time (S1300: NO), and proceeds to step S1600 if the non-operation time reaches the predetermined time (S1300: YES).

In step S1600, operation status detection section 240 allows program information acquisition section 241 to determine whether the broadcasting scheme is the low-definition standard based on the broadcast standard information. If the broadcasting scheme is not the low-definition standard (S1600: NO), operation status detection section 240 proceeds to step S1700. If the broadcasting scheme is the low-definition standard (S1600: YES), operation status detection section 240 proceeds to step S1650.

In step S1650, operation status detection section 240 determines whether the battery level is a given threshold value or less. Operation status detection section 240 returns to step S1100 if the battery level is greater than the given threshold value (S1650: NO), and proceeds to step S1800 if the battery level is the given threshold value or less (S1650: YES). Alternatively, operation status detection section 240 may proceed to step S1800 if the non-operation time also reaches a predetermined threshold value, as with in step S1300, in addition to the above determination process for the battery level.

In step S1700, operation status detection section 240 allows broadcast standard switching determination section 243 to acquire the last program information (i.e. program information at the time when the last television operation is performed) among pieces of the program information stored in program information storage area 242. Furthermore, operation status detection section 240 acquires program information (i.e. current program information) from program information acquisition section 241.

Then, in step S1900, operation status detection section 240 allows broadcast standard switching determination section 243 to determine whether program change occurs within non-operation time or within a predetermined time after the non-operation time based on the program information. Specifically, operation status detection section 240 determines whether program change occurs by determining whether the program indicated by the program information at the time of the last television operation is the program indicated by the current program information. Operation status detection section 240 returns to step S1100 if the program change does not occur (S1900: NO) and proceeds to step S2000 if the program change occurs (S1900: YES). For the length of the above predetermined time, any values of 0 or greater can be set. The predetermined time, however, is preferably short enough during which the user is estimated to be not viewing the television application in view of the timing of program change.

In step S2000, operation status detection section 240 allows broadcast standard switching determination section 243 to output a broadcast standard instruction giving an instruction on switching to the low-definition standard to broadcast standard switching processing section 250, and returns to step S1100.

In step S1800, operation status detection section 240 allows broadcast standard switching determination section 243 to output a broadcast standard instruction giving an instruction on the end of the television application to broadcast standard switching processing section 250, and complete a series of the process.

With this operation, operation status detection section 240 can output the broadcast standard instruction giving an instruction on switching to the low-definition standard if non-operation time reaches the predetermined time and when program change occurs during the non-operation time in the high-definition standard. Operation status detection section 240 can output the broadcast standard instruction giving an instruction on switching to the high-definition standard if the television operation is performed in the low-definition standard. Furthermore, operation status detection section 240 can output the broadcast standard instruction giving an instruction on the end of the television application if non-operation time reaches the predetermined time while no television operation is performed in the low-definition standard.

Operation status detection section 240 may determine whether the program change occurs by comparing the current program information with the program information at any time during non-operation time, not with the program information at the starting time of the non-operation time. Specifically, operation status detection section 240 performs the process of step S1400 immediately before step S1600, for example. In this case, broadcast receiving terminal 100 detects the occurrence of program change at the timing of the first program change after non-operation time has elapsed, and thus performs switching to the high-definition standard at the timing of switching to the next program, not in the middle of the program. With this configuration, broadcast receiving terminal 100 can lessen the impact of abrupt reduced image quality on the user.

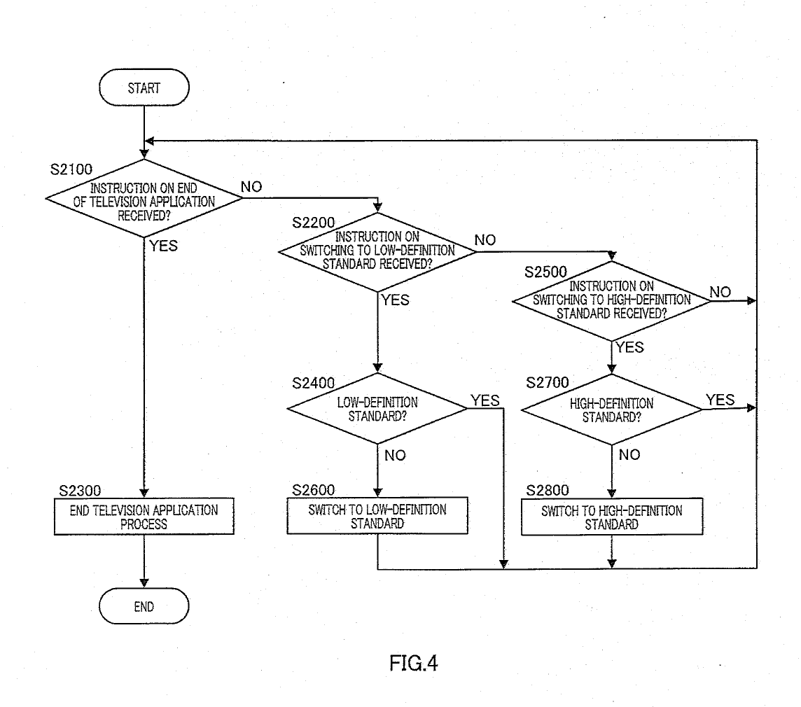

FIG. 4 is a flowchart showing an operation of broadcast standard switching processing section 250. It is noted that broadcast standard switching processing section 250 can always confirm which broadcasting scheme reception processing section 140 is currently using to perform the reception process.

First, in step S2100, broadcast standard switching processing section 250 determines whether it receives the broadcast standard instruction giving an instruction on the end of the television application from operation status detection section 240. If not receiving the broadcast standard instruction (S2100: NO), broadcast standard switching processing section 250 proceeds to step S2200. If receiving the broadcast standard instruction (S2100: YES), broadcast standard switching processing section 250 proceeds to step S2300.

In step S2200, broadcast standard switching processing section 250 determines whether it receives the broadcast standard instruction giving an instruction on switching to the low-definition standard from operation status detection section 240. If receiving the broadcast standard instruction (S2200: YES), broadcast standard switching processing section 250 proceeds to step S2400. If not receiving the broadcast standard instruction (S2200: NO), broadcast standard switching processing section 250 proceeds to step S2500.

In step S2400, broadcast standard switching processing section 250 determines whether the broadcasting scheme is the low-definition standard. Broadcast standard switching processing section 250 returns to step S2100 if the broadcasting scheme is the low-definition standard (S2400: YES), and proceeds to step S2600 if the broadcasting scheme is not the low-definition standard (i.e. the broadcasting scheme is the high-definition standard) (S2400: NO).

In step S2600, broadcast standard switching processing section 250 causes reception processing section 140 to switch the broadcasting schemes to the low-definition standard, and returns to step S2100.

Furthermore, in step S2500, broadcast standard switching processing section 250 determines whether it receives the broadcast standard instruction giving an instruction on switching to the high-definition standard from operation status detection section 240. If receiving the broadcast standard instruction (S2500: YES), broadcast standard switching processing section 250 proceeds to step S2700. If not receiving the broadcast standard instruction (S2500: NO), broadcast standard switching processing section 250 returns to step S2100.

In step S2700, broadcast standard switching processing section 250 determines whether the broadcasting scheme is the high-definition standard. Broadcast standard switching processing section 250 returns to step S2100 if the broadcasting scheme is the high-definition standard (S2700: YES), and proceeds to step S2800 if the broadcasting scheme is not the high-definition standard (i.e. the broadcasting scheme is the low-definition standard) (S2700: NO).

In step S2800, broadcast standard switching processing section 250 causes reception processing section 140 to switch the broadcasting schemes to the high-definition standard, and returns to step S2100.

In step S2300, broadcast standard switching processing section 250 performs a process of causing reception processing section 140 to stop the reception process (i.e. process of stopping the television application), and completes a series of the process.

With this operation, broadcast standard switching processing section 250 can control the broadcasting scheme switching and the end of the reception process in reception processing section 140 according to the instructions from operation status detection section 240.

As explained above, broadcast receiving terminal 100 according to the present embodiment switches the broadcasting schemes to the low-definition standard if no television operation is performed in response to the program change in the high-definition standard. With this configuration, in the case where program change occurs while the user is not viewing the program, broadcast receiving terminal 100 can switch the broadcasting schemes to the low-definition broadcast consuming less power. Thus, it is possible to reduce waste power consumption which may not be expected by the user. Accordingly, broadcast receiving terminal 100 can reduce unnecessary power consumption that may occur, for example, in the case where the user forgets to end the television application.

Furthermore, broadcast receiving terminal 100 limits the operation of a terminal that is subject to the determination of switching to the low-definition standard or stop of the reception process to the television operation. Hence, broadcast receiving terminal 100 can prevent inappropriate extension of the counted time of non-operation time from extending and prevent the high-definition standard and the reception process from continuing? while the user is not viewing the program. Furthermore, broadcast receiving terminal 100 can adjust the balance between power reduction and achievement of the required audio quality and image quality in accordance with the purpose of the use.

Broadcast receiving terminal 100 may not switch the broadcasting schemes to the low-definition standard in the case where the battery level can afford the reception process even if the broadcast is continued in the high-definition standard until the end of the receiving program, especially during recording of the program. In this case, for example, broadcast receiving terminal 100 acquires the remaining time of the current program from the program information, for example, and calculates the power consumption for continuing the broadcast in the high-definition standard for the acquired remaining time. Then, broadcast receiving terminal 100 compares the calculated power consumption with the battery level indicated by the battery information, and does not give an instruction on switching to the low-definition standard if the calculated power consumption exceeds the battery level. With this configuration, broadcast receiving terminal 100 can continue displaying a program in the high-definition standard when the battery level is sufficient enough while reducing waste power consumption which may not be expected by the user.

Alternatively, broadcast receiving terminal 100 may change the above-described predetermined time, which is used as the reference for determining whether to switch the broadcasting schemes to the low-definition standard, according to the battery level, the type of program, viewing style of the user, and other conditions. In this case, for example, broadcast receiving terminal 100 stores in advance a table in which each condition is associated with a predetermined time corresponding to that condition. Then, broadcast receiving terminal 100 determines the current condition and selects the predetermined time corresponding to the determined condition. Broadcast receiving terminal 100 may extend the length of the predetermined time in the following cases: where the battery level is high, where the program falls upon some type which may not often receive the television operation, such as classical music performance, where the viewing style falls upon some type which may not often receive the television operation, such as the case where only audio of the program is output from a closed broadcast receiving terminal 100. Likewise, broadcast receiving terminal 100 may change the above-described predetermined threshold value according to various conditions. With the above techniques, broadcast receiving terminal 100 can also continue displaying a program in the high-definition standard where possible while reducing waste power consumption which may not be expected by the user.

Alternatively, broadcast receiving terminal 100 may change the above-described predetermined time that is used as the reference for determining whether to switch the broadcasting schemes to the low-definition standard according to the battery level. In this case, broadcast receiving terminal 100, for example, creates, in advance, a correspondence between the battery level and the predetermined time, where a longer predetermined time is associated with higher battery level, and changes the predetermined time according to the battery level. Likewise, broadcast receiving terminal 100 may change the above-described predetermined threshold value according to the battery level. With the above techniques, broadcast receiving terminal 100 can also continue displaying a program in the high-definition standard where possible when the battery level is sufficient enough, while reducing waste power consumption which may not be expected by the user.

Alternatively, broadcast receiving terminal 100 may separately set times before and after the program change and switch the broadcasting schemes to the low-definition standard when no television operation is performed during the both times in the high-definition standard. In this way, separately setting times and setting the length of the times appropriately can prevent the broadcasting schemes from being switched to the low-definition standard even though the television operation has been performed immediately before and after the program change.

Alternatively, in the above embodiment, broadcast receiving terminal 100 defines the condition in which non-operation time elapses and program change occurs during the non-operation time as a trigger for switching to the low-definition standard or stop of the reception process. Broadcast receiving terminal 100, however, may define only the occurrence of the program change as the trigger for switching to the low-definition standard or stopping the reception process. This is because the image quality level required by the user or the frequency of viewing by the user may lower in line with the program change. This can further reduce the waste power consumption which may not be expected by the user. Furthermore, the user can immediately switch the broadcasting scheme to the high-definition standard when necessary by performing the television operation.

Alternatively, broadcast receiving terminal 100 may switch the broadcasting schemes to the low-definition standard or stop the reception process at the same time of the detection of the program change in the case where broadcast receiving terminal 100 defines the occurrence of program change during non-operation time or during a subsequent predetermined time as the above trigger. With this configuration, switching to a power reduction operation can be performed approximately at the same time of the program change and waste power consumption which may not be expected by the user can be reduced.

Furthermore, in the above embodiment, the high-quality broadcasting scheme and the low-quality broadcasting scheme are defined as full-segment broadcast and one-segment broadcast, respectively. The present invention, however, is not limited to this application. Furthermore, the present invention can be applied to various types of broadcast other than the television broadcast, the various types of broadcast employing a plurality of broadcasting schemes consuming different power, such as digital radio broadcast. That is, the important feature of the present invention is to switch the quality standards for broadcast between the high-quality standard consuming greater power and the low-quality standard consuming smaller power: for example, in the standard for a digital radio, the high-quality standard and the low-quality standard correspond to the high audio quality standard and the low audio quality standard, respectively. The present invention can be applied to systems employing various combinations of a high-quality broadcasting scheme and a low-quality broadcasting scheme in which a user can view a single program using both schemes.

The disclosure of Japanese Patent Application No. 2010-102294, filed on Apr. 27, 2010, including the specification, drawings and abstract, is incorporated herein by reference in its entirety.

### INDUSTRIAL APPLICABILITY

The broadcast receiving apparatus according to the present invention is useful as an apparatus and method for receiving broadcast that can reduce the waste power consumption which may not be expected by the user.

### REFERENCE SIGNS LIST

100 broadcast receiving terminal
110 broadcast antenna
120 tuner section corresponding to high-definition standard
130 tuner section corresponding to low-definition standard
140 reception processing section
150 audio processing section
160 speaker
170 video processing section
180 display
190 terminal operation detection section
200 front screen display detection section
210 terminal open/close detection section
220 battery
230 battery level detection section
240 operation status detection section
241 program information acquisition section
242 program information storage area
243 broadcast standard switching determination section
244 timer
250 broadcast standard switching processing section
260 screen display processing section

1. A broadcast receiving apparatus comprising:
a reception processing section that receives broadcast data of a program by switching broadcasting schemes between a high-quality broadcasting scheme and a low-quality broadcasting scheme consuming less power than the high-quality broadcasting scheme;
a program output section that outputs the program based on the received broadcast data;
a battery level detection section that detects a remaining battery level; and
a broadcast standard switching processing section that, in the high-quality broadcasting scheme, causes the reception processing section to switch the broadcasting schemes to the low-quality broadcasting scheme if no terminal operation is performed in a predetermined period from a reference point when the program changes to the next one, the predetermined period varying according to the detected remaining battery level.

2. The broadcast receiving apparatus according to claim 1, wherein the broadcast standard switching processing section causes the reception processing section to stop the reception of the broadcast data if the remaining battery level is a threshold value or less or if the length of a time in which the terminal operation is not performed in response to the change in program is a threshold value or greater.

3. (canceled)

4. (canceled)

5. The broadcast receiving apparatus according to claim 1, wherein the predetermined period includes the time of the change in program.

6. The broadcast receiving apparatus according to claim 1, wherein the terminal operation relates to the program.

7. The broadcast receiving apparatus according to claim 1, wherein the terminal operation is performed during output of the program.

8. The broadcast receiving apparatus according to claim 1, wherein the broadcast standard switching processing section causes the reception processing section to switch the broadcasting schemes to the low-quality broadcasting scheme at a time of the change to the next program.

9. The broadcast receiving apparatus according to claim 1, wherein the broadcast standard switching processing section causes the reception processing section to switch the broadcasting schemes to the high-quality broadcasting scheme if the terminal operation is performed in the low-quality broadcasting scheme.

10. The broadcast receiving apparatus according to claim 1, further comprising a screen display processing section that displays information about the switching of broadcasting schemes on a screen.

11. A broadcast receiving method comprising:
starting reception of broadcast data of a program in accordance with a high-quality broadcasting scheme;
starting output of the program based on the received broadcast data;
detecting a remaining battery level;
determining a predetermined period using a time when the program changes to the next one as a reference based on the detected remaining battery level, the predetermined period varying depending on the detected remaining battery level;
determining whether a terminal operation is performed in the predetermined period; and
switching schemes for the reception from the high-quality broadcasting scheme to a low-quality broadcasting scheme if no terminal operation is performed in predetermined period, the low-quality broadcasting scheme consuming less power than the high-quality broadcasting scheme.
